(19) United States
(12) Patent Application Publication
(10) Pub. No.: US 2018/0010761 A1
(43) Pub. Date: Jan. 11, 2018

(54) COLLAPSIBLE LAMPSHADE ASSEMBLY

(71) Applicant: MASTERCRAFT INTERNATIONAL LIMITED, Kowloon (HK)

(72) Inventor: Li Mei HONG, Dongguan City (CN)

(21) Appl. No.: 15/201,872

(22) Filed: Jul. 5, 2016

(51) Int. Cl. F21V 1/06; F21V 1/14; F21V 1/12

(52) U.S. Cl. CPC F21V 1/06; F21V 1/12; F21V 1/143

(57) ABSTRACT

A collapsible lampshade assembly is disclosed. The collapsible lampshade assembly includes a shade, a first frame for maintaining a shape of the shade and for connecting to a harp of a light fixture, a second frame for maintaining the shape of the shade, a first plurality of pins disposed on a first edge of the shade for preventing the shade from being separated from the first frame by placing the first frame below the first plurality of pins, and a second plurality of pins disposed on a second edge of the shade from preventing the second frame by placing the second frame on the second plurality of pins

### BACKGROUND OF THE INVENTION

### 1. Field of the Invention

The present disclosure relates to a collapsible lampshade assembly.

### 2. Description of the Prior Art

Lampshade assemblies are known in the art and are commonly used as home and office applications for softening or directing the lamp light. Although some lampshades are economically made, some of the economic benefit is lost because of their bulk relative to their weight. While the basic structure of a lampshade has not materially changed, there are myriad efforts to fashion the basic elements in a manner which permits them to be formed as separable units and later assembled, thereby minimizing the bulk for shipping. One of such lampshade assemblies is disclosed in U.S. Pat. No. 7,267,458 wherein the lamp assembly uses a clip-type holder to hold a frame. The clip-type holder comprises a pair of jaws, running parallel to the plane of the top and bottom of the lampshade assembly. Another lampshade assembly is disclosed in United States Patent Publication No. 2008/0130297 wherein the lampshade assembly uses another clip-type holder to hold a frame. The clip-type holder is fixed between the inner liner and the cover of the shade, and the frame is adapted to snap into the clip-type holder. Another lampshade assembly is disclosed in United States Patent Publication No. 2015/0029730 wherein the lampshade assembly uses Velcro tapes or magnetic stickers on the inner liner and on the outer surfaces of the frame.

### SUMMARY OF THE INVENTION

In an aspect of the disclosure, a collapsible lampshade assembly and a method to assemble a collapsible lampshade assembly are provided. The assembly includes a shade, a first frame for maintaining a shape of the shade and for connecting to a harp of a light fixture, a second frame for maintaining the shape of the shade, a first plurality of pins disposed on a first edge of the shade for preventing the shade from being separated from the first frame by placing the first frame below the first plurality of pins, and a second plurality of pins disposed on a second edge of the shade from preventing the second frame by placing the second frame on the second plurality of pins.

The method for assembling a collapsible lampshade assembly includes erecting a collapsed lampshade; extending the collapsed lampshade to an installed shape of the lampshade; putting a second frame in the lampshade; placing the second frame in a parallel way with a second edge of the lampshade; putting down the second frame until the second frame is placed on a second plurality of pins disposed on the second edge of the lampshade; putting a first frame in the lampshade; placing the first frame in a parallel way with a first edge of the lampshade; lifting the first frame until the first frame is placed below a first plurality of pins disposed on the first edge of the lampshade.

### ADVANTAGES OF THE INVENTION

Several advantages of one or more aspects of the invention are that it provides for an inexpensive, easily-assembled, easily-maintained, and compact structure for shipping and using. The invention uses simpler parts and requires less time to assemble and disassemble than other collapsible lampshade assemblies of the prior art, therefore reducing capital and assembly expenses and providing for a structure that is easier to maintain. Moreover, when the lampshade is collapsed, the collapsed lampshade assembly minimizes the bulk for shipping, therefore providing for a compact assembly.

### BRIEF DESCRIPTION OF THE FIGURES (NON-LIMITING EMBODIMENTS OF THE DISCLOSURE)

Other advantages of the present invention will be readily appreciated, as the same becomes better understood by reference to the following detailed description when considered in connection with the accompanying drawings wherein:

FIG. 1 is a prospective view of the assembled collapsible lampshade assembly.

FIG. 2 is a prospective view of another embodiment of the assembled collapsible lampshade assembly.

FIG. 3 is a perspective view of the disassembled collapsible lampshade assembly.

FIG. 4 is a cross-sectional view of an edge of the collapsible lampshade assembly.

FIG. 5 is a partial prospective view of an edge of the collapsible lampshade assembly before a shade trim tape covers a pin.

FIG. 6 is a partial prospective view of an edge of the collapsible lampshade assembly after a shade trim tape covers a pin.

FIG. 7 is a partial prospective view of an edge of the collapsible lampshade assembly with a peripheral tape band.

FIG. 8 is a partial cross-sectional view of an edge of another embodiment of the collapsible lampshade assembly.

### DETAILED DESCRIPTION

Reference will now be made to detailed embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, and components have not been described in detail so as not to unnecessarily obscure aspects of the embodiments.

In the following description of the invention, certain terminology is used for the purpose of reference only, and is not intend to be limiting. Terms such as “upper”, “lower”, “above”, and “below,” refer to directions in the drawings to which reference is made. Terms such as “inwards” and “outward” refer to directions towards and away from, respectively, the geometric center of the component described. Terms such as “side”, “top”, “bottom,” “horizontal,” and “vertical,” describe the orientation of portions of the component within a consistent but arbitrary frame of reference which is made clear by reference to the text and the associated drawings describing the component under discussion. Such terminology includes words specifically mentioned above, derivatives thereof, and words of similar import.

It will also be understood that, although the terms first, second, etc. may be used herein to describe various elements, these elements should not be limited by these terms. These terms are only used to distinguish one element from another. For example, a first member could be termed a second member, and, similarly, a second member could be termed a first member, without departing from the scope of the present invention.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed terms. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Referring to the Figures, wherein like numerals indicate corresponding parts throughout the several views, a collapsible lampshade assembly 10 having a shade 30, a first frame 11 for maintaining a shape of the shade 30 and for connecting to a harp of a light fixture; a second frame 41 for maintaining the shape of the shade 30; a first plurality of pins 22 adjacent to a first edge of the shade 30 for preventing the shade 30 from being separated for the first frame 11 by placing the first frame 11 below the first plurality of pins 22; and a second plurality of pins 23 adjacent to a second edge of the shade 30 for preventing the shade 30 from being separated from the second frame 41 by placing the second frame 41 on the second plurality of pins 23 is generally shown.

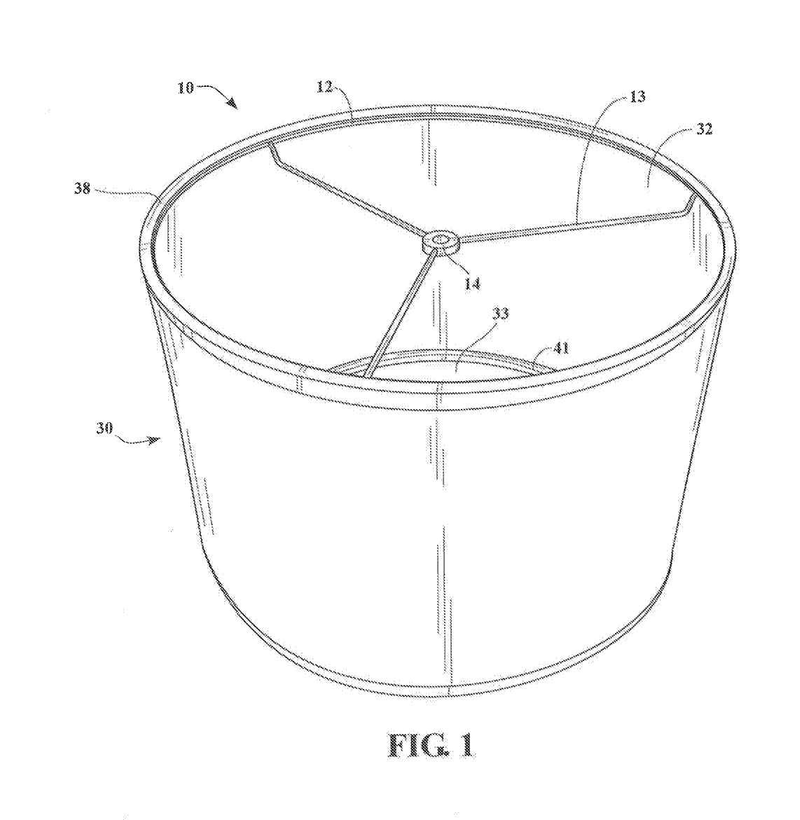

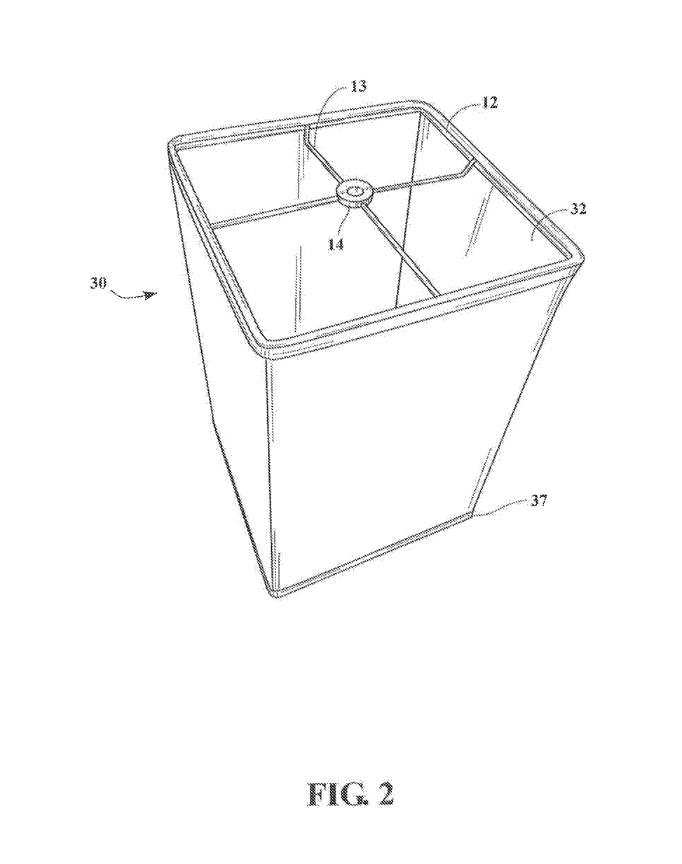

In FIG. 1, the assembled collapsible lampshade assembly 10 is shown. FIG. 2 shows another embodiment of the assembled collapsible lampshade assembly. As shown in FIGS. 1 and 2, the shapes of the open bases 32 and 33 could be oval and rectangular.

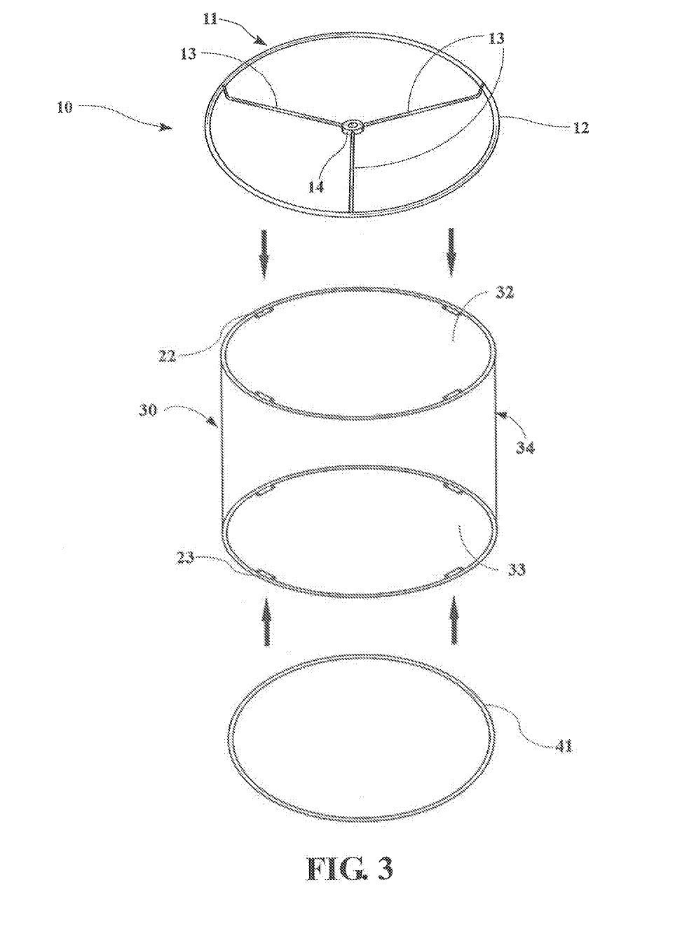

As shown in FIG. 3, the first frame 11 defines an outer frame 12, a fitter 14 at the center of the outer frame 12 for sitting on a reducer of the harp of a light fixture, and a plurality of legs 13 radiating from the fitter 14 to the outer frame 12. The outer frame 12 has a circular shape. However, it should be appreciated that the outer frame 12 could have other shapes such as, but not limited to, an oval, square, rectangle, pentagon, octagon, or hexagon shape. The first frame 11 is made out of a metal material. However, it should be appreciated that the first frame 11 could be made out of other materials such as, but not limited to natural polymeric materials which are strong enough to hang the shade 30 on the outer frame 12 with the second frame 41 or a rigid polyvinyl chloride. The fitter 14 is disposed at the center of the outer frame 12 for the collapsible lampshade assembly 10 to sit on a reducer of the harp of a light fixture. Accordingly, the center of the fitter 14 has a hole for the reducer disposed at the top of the harp to fit into the hole. The size of the hole could be various depending on the diameter of commercial reducers. The position of the fitter 14 could have the same height with the height of the outer frame 12 when the lamp shade assembly 10 is properly installed. However, it should be appreciated that the height of the fitter 14 could be lower or higher than the height of the outer frame 12 when the lamp shade assembly 10 is installed. The plurality of legs 13 are elongated members to connect the fitter 14 and the outer frame 12. However, it should be appreciated that the shape of the leg 13 could be different to connect the fitter 14 and the outer frame 12. In this embodiment, the first frame 11 has three legs 13. However, it should be appreciated that the number of legs could be different, but not limited to, four, five, six, or eight.

The second frame 41 has a circular shape. However, it should be appreciated that the second frame 41 could have other shapes such as, but not limited to, an oval, square, rectangle, pentagon, octagon, or hexagon shape. The shape of the second frame 41 is generally the same as the shape of the outer frame 12. However, it should be appreciated that the shape of the second frame 41 could be different from the shape of the outer frame 12. The size of the second frame 41 is also generally the same as the size of the outer frame 12. However, the size of the second frame 41 may be different from the size of the outer frame 12. Moreover, even if the shape of the second frame 41 is same with the shape of the outer frame 12, the size of the second frame 41 could be different from the size of the outer frame 12. For example, the diameter of the circular-shape second frame 41 could be longer than the diameter of the circular-shape outer frame 12. The second frame 41 is made out of a metal material. However, it should be appreciated that the second frame 41 could be made out of other materials such as, but not limited to natural polymeric materials or a rigid polyvinyl chloride.

The shade 30 is disposed between the first frame 11 and the second frame 41 to soften or direct the lamp light. The lamp light is disposed in the shade 30. The shade 30 has a circular cylindrical shape having two parallel open ends 32 and 33 connected by a curved surface 34. However, it should be appreciated that the shade 30 could have other shapes such as, but not limited to, an oval cylindrical, cubical, rectangular parallelepiped, pentagon parallelepiped, octagon parallelepiped, or hexagon parallelepiped shape. One open base 32 has the same shape and size with the shape and size of the outer frame 12. The other open base 33 has the same shape and size with the shape and size of the second frame 41. The shade 30 is collapsible when the shade is separated from the first and second frames 11 and 41. The collapsed shade 30 and the first and second frames 11 and 41 are suitable for shipping and maintenance because they reduce the size of the shipping or storing package. The reduced size of the package is more sustainable from the force outside more than shipping or storing a lamp shade while maintaining the basic structure of the lamp shade.

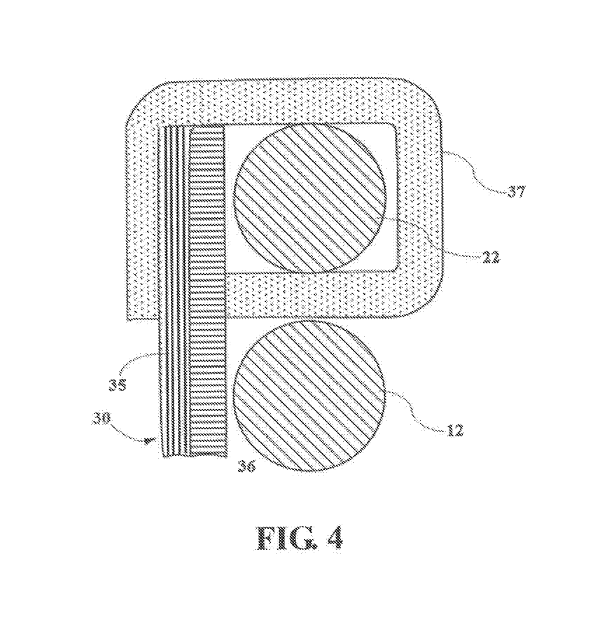

As shown FIG. 4, the shade 30 defines a lining 36 and a cover 35 attached on the lining 36 for ornamenting the external appearance of the collapsible lampshade 10. The lining 36 is pliable enough to be bent but hard enough to form the shape of the collapsible lampshade 10. The pliable lining 36 makes the shade 30 collapsible in a parallel way to the ground if the collapsible lampshade is in the set-up position. Thus, the shape of the open bases 32 and 33 would change to the shape fitting in to the shipping package. For example, the circle shape of the open bases 32 and 33 could be oval. The rectangle shape of the open bases 32 and 33 could be a diamond shape. If the shape of the outer frame 12 and the second frame 41 is, but not limited to, a square, rectangle, pentagon, octagon, or hexagon shape, the lining 36 could be made out of, but not limited to, glass, acrylic glass, rigid polyvinyl chloride or a metal material, which is not a pliable material. The lining 36 is generally made out of a translucent material to soften the lamp light. However, the lining 36 could be made out of a transparent or opaque material. The lining 36 is hard enough to form a basic lampshade structure if the first and second frames 12 and 41 are installed in the shade 30. The cover 35 is attached on the outside 34 of the lining 36 to have an effect to disperse the lamp light in the shade 30. The cover 35 is made out of, but not limited to, a Linen fabric, silk, wool, or cotton. The cover 35 may also have a decoration for ornamenting the external appearance of the collapsible lampshade.

The first plurality of pins 22 are attached on the inside of the lining 36. If the first frame 11 is put in the shade and properly installed in a perpendicular angle to the curved surface 34 of the shade 30, the first plurality of pins 22 prevent the first frame 11 from being separated from the shade 30. It is because the size of the first open end 32 is the same as the size of the first frame 11. Similarly, the second plurality of pins 23 are attached on the inside of the lining 32. If the second frame 41 is put in the shade and properly installed in a perpendicular angle to the curved surface 34 of the shade 30, the first plurality of pins 22 prevent the first frame 11 from being separated from the shade 30. It is because the size of the second open end 33 is the same as the size of the second frame 41. The plurality of pins 22 and 23 have a shape of cylinder. However, it should be appreciated that the plurality of pins 22 and 23 could have other shapes such as, but not limited to, a hexahedron.

The shade trim tape 37 having an adhesive surface is taped on the outside of the cover 35 and the inside of the lining 36. The shade trim tape encloses a pin 22 to fasten the pin 22 adjacent to the edge of the shade 30. Since the pin 22 is fastened adjacent to the edge of the shade 30, the outer frame 12 is prevented from moving out of the shade 30. This mechanism applies to the other plurality of pins 22 and 23 adjacent to upper edge and lower edge of the shade 30.

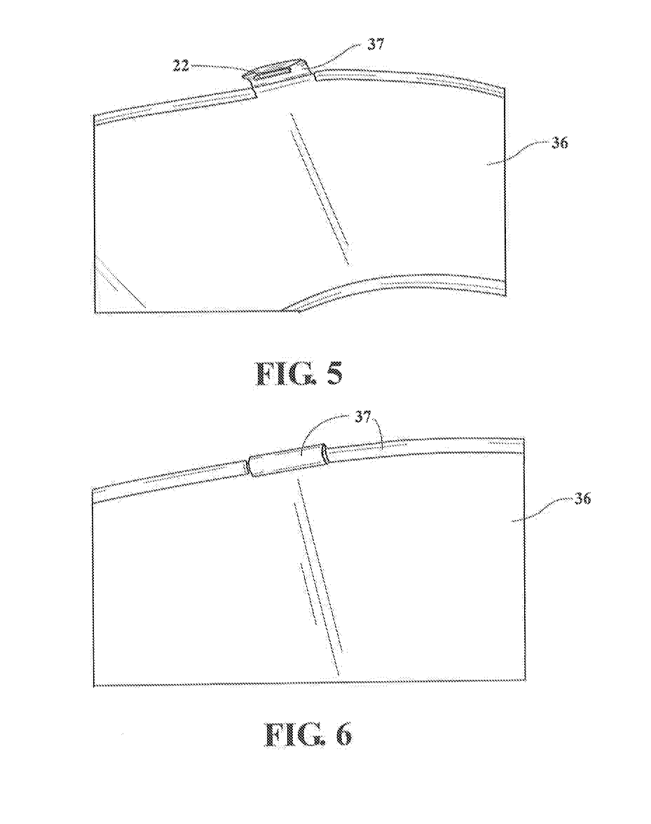

As shown in FIGS. 5-6, the edges of the shade 30 are taped by upper and lower shade trim tapes 37. Each shade trim tape 37 is attached on the cover 35 and the lining 36 covering the upper and lower edges of the shade 30. A portion of the shade trim tape 37 is cut into a plurality of tabs at a right angle to the edge of the shade trim tape 37. Each shade trim tape 37 is attached on the lining 36 such that the tabs covers the plurality of pins 22 and 23 and are wrapped around the plurality of pins 22 and 23 to hold them in place. Since the plurality of pins 22 and 23 are disposed between the inside of the lining 36 and each shade trim tape 37, the plurality of pins 22 and 23 themselves are invisible. The shade trim tape portions between the tabs are attached inside of the lining 36 without contacting the plurality of pins 22 and 23.

As shown in FIG. 5, a first plurality of pins 22 may be adjacent to a first edge of the shade 30 for preventing the shade 30 from being separated from the first frame 11 due to the gravity force of the shade 30 by placing the first frame 11 below the first plurality of pins 22, and a second plurality of pins 23 disposed on a second edge of the shade 30 from preventing the second frame 41 from being separated from the shade 30 due to the gravity force of the second frame 41 by placing the second frame 41 on the second plurality of pins 23. The plurality of pins 22 and 23 may have about 1 inch (2.54 cm) length and 0.1 inch (0.25 cm) diameter. However, it should be appreciated that the size of the plurality of pins 22 and 23 could be different sizes. In particular, if the shape of the outer frame 12 and the second frame 41 is a round shape, the length of the plurality of pins 22 and 23 should be short enough not to distort the round shape. The plurality of pins 22 and 23 may be a curved shape. If the shape of the outer frame 12 and the second frame 41 is a square, rectangle, pentagon, octagon, or hexagon shape, the length of the plurality of pins 22 and 23 may be equal or less than the length of the side of the square, rectangle, pentagon, octagon, or hexagon shape, respectively. The length of the plurality of pins 22 and 23 may be equal to one side of the outer frame 12 and the second frame 41. If so, the cut shade trim tape 37 has equal or longer than the length of the plurality of pins 22 and 23 to cover and hide the plurality of pins 22 and 23. The plurality of pins 22 and 23 may be made out of a metal material. However, it should be appreciated that the plurality of pins 22 and 23 could be made out of other materials such as, but not limited to natural polymeric materials or a rigid polyvinyl chloride.

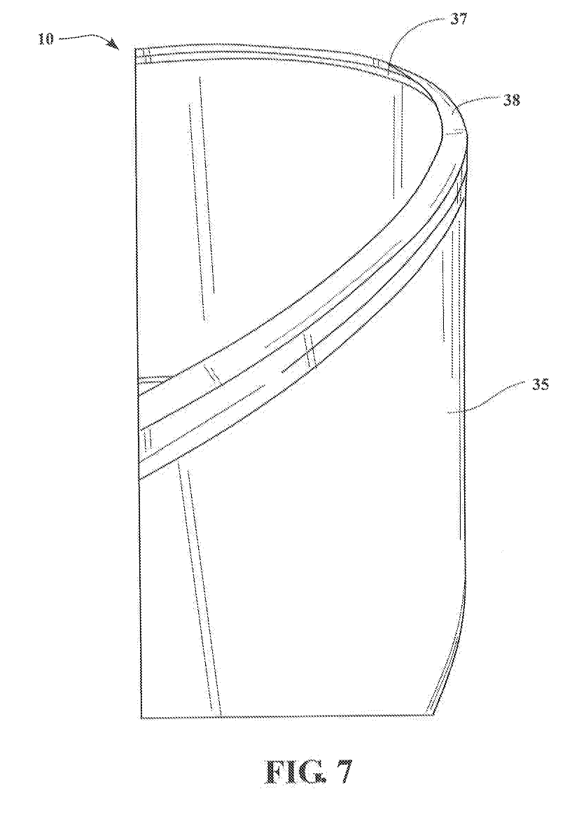

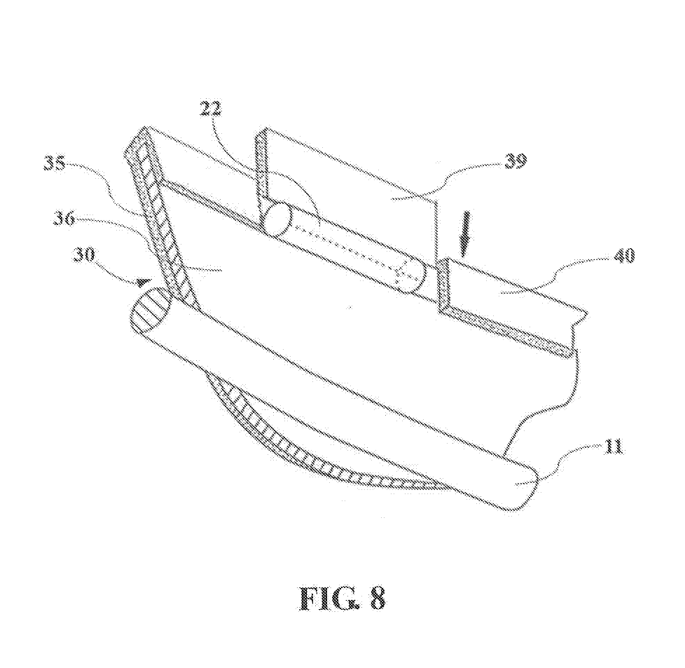

As shown FIG. 7, peripheral tape bands 38 may encircle the upper and lower edges of the shade 30 and hide the outer and second frames 12 and 41 and the shade trim tape 37 when the frames are installed in the shade 30.

As shown in FIG, 8, extra portions 39 and 40 of the cover 35 may be used in place of the shade trim tape 37. In this embodiment, the cover 35 is wider than the width of the lining 36. In particular, both edges of the lining 36 are covered by the cover 35, The extra portions 39 and 40 of the cover 35 may be adhesively attached on the inside of the lining 36. The extra portions of the cover 35 are cut at right angles to form tabs 39 and portions 40. The plurality of pins 22 and 23 are adhesively attached on the inside of the lining 36 by the tabs 39. Since the plurality of pins 22 and 23 are disposed between the inside of the lining 36 and covered by the tabs 39, the plurality of pins 22 and 23 themselves are invisible. The portions 40 of the cover 35 are attached inside of the lining 36. A peripheral tape bands 38 may be attached over the edges of the shade 30 as in the first embodiment.

The foregoing description, for purpose of explanation, has been described with reference to specific embodiments. However, the illustrative discussion above is not intended to be exhaustive or to limit the invention to the precise forms disclosed. Many modifications and variations are possible in view of the above teachings. The embodiments were chosen and described in order to explain the principle of the invention and some of its practical applications, to thereby enable others skill in the art to best utilize the invention and various embodiments with various modifications as are suited to the particular use contemplated.

1. A collapsible lampshade comprising:
a first frame for maintaining an shape of said collapsible lampshade and for sitting on a harp;
a second frame for maintaining said shape of said collapsible lampshade;
a shade enclosing said first frame and said second frame; and
a plurality of cylindrical pins attached on the inside of said shade for preventing said first and second frames from being separated from said shade.

2. The collapsible lampshade as set forth in claim 1 wherein said first frame comprises an outer frame, a fitter at the center of said outer frame for sitting on a reducer of said harp, and a plurality of legs radiating from said fitter to said outer frame.

3. The collapsible lampshade as set forth in claim 1 wherein said shade comprises a lining and a cover attached on said lining for ornamenting the external appearance of said collapsible lampshade.

4. The collapsible lampshade as set forth in claim 3 wherein said lining is pliable enough to be bent but hard enough to form said shape of said collapsible lampshade.

5. The collapsible lampshade as set forth in claim 3 wherein said cover and lining are made of translucent materials.

6. A collapsible lampshade comprising:
a first frame for maintaining an shape of said collapsible lampshade and for sitting on a harp;
a second frame for maintaining said shape of said collapsible lampshade;
a shade enclosing said first frame and said second frame;
a first plurality of cylindrical pins disposed on a first edge of said shade for preventing said shade from being separated from said first frame due to the gravity force of said shade by placing said first frame below said first plurality of pins; and
a second plurality of cylindrical pins disposed on a second edge of said shade from preventing said second frame from being separated from said shade due to the gravity force of said second frame by placing said second frame on said second plurality of pins.

7. The collapsible lampshade as set forth in claim 6 wherein said first frame comprises an outer frame, a fitter at the center of said outer frame for sitting on a reducer of said harp, and a plurality of legs radiating from said fitter to said outer frame.

8. The collapsible lampshade as set forth in claim 6 wherein said shade comprises a lining and a cover attached on said lining for ornamenting the external appearance of said collapsible lampshade.

9. The collapsible lampshade as set forth in claim 8 wherein said lining is pliable enough to be bent but hard enough to form said shape of said collapsible lampshade.

10. The collapsible lampshade as set forth in claim 8 wherein said cover and lining are made of translucent materials.

11. A collapsible lampshade comprising:
a first frame for maintaining an shape of said collapsible lampshade and for sitting on a harp;
a second frame for maintaining said shape of said collapsible lampshade;
a lining enclosing said first frame and said second frame;
a cover attached on said lining; and
a plurality of pins attached on the inside of said lining for preventing said first and second frames from being separated from said shade,
wherein said cover is attached on the inside of said lining and said plurality of pins are disposed between said lining and said cover.

12. The collapsible lampshade as set forth in claim 11 wherein said first frame comprises an outer frame, a fitter at the center of said outer frame for sitting on a reducer of said harp, and a plurality of legs radiating from said fitter to said outer frame.
